(19) United States
(12) Patent Application Publication
(10) Pub. No.: US 2016/0121804 A1
(43) Pub. Date: May 5, 2016

(54) HOLDER

(71) Applicant: Barry Stephen ROBINSON, II, Culpeper, VA (US)

(72) Inventor: Barry Stephen ROBINSON, II, Culpeper, VA (US)

(21) Appl. No.: 14/671,107

(22) Filed: Mar. 27, 2015

Related U.S. Application Data
(60) Provisional application No. 62/122,842, filed on Oct. 31, 2014.

(51) Int. Cl. B60R 11/02; A45F 5/02

(52) U.S. Cl. CPC B60R 11/02; A45F 5/021; B60R 2011/0059

(57) ABSTRACT

A holder is provided which includes a first connection member having at least one coupling member, a mobile device holding member rotatably attached to the first connection member and configured to accommodate a mobile device therein, a second connection member including at least one receiving member configured to receive the at least one coupling member, and an attachment member configured to be attached to an external device. The first connection member is interposed between the mobile device holding member and the second connection member. The at least one coupling member is detachably attached to the at least one receiving member.

### CROSS-REFERENCE TO RELATED APPLICATION

This application claims priority to and the benefit of U.S. Provisional Patent Application No. 62/122,842, filed on Oct. 31, 2014, the disclosure of which is incorporated herein by reference in its entirety.

### FIELD OF THE INVENTION

The present invention generally relates to a holder, and more particularly to a mobile device holder in a car.

### BACKGROUND OF THE INVENTION

An increasing number of mobile devices are currently available to users, and in particular to vehicle drivers. Mobile devices make it possible to assist the vehicle drivers to determine a route, obtain traffic information, or help the drivers in driving the vehicle. Such devices are for example controlled by a touchscreen that must therefore be accessible to the drivers without requiring him/her to hold the device in his/her hand, which would constitute a hazard in driving the vehicle. Using mobile device is sometimes problematic since there is no convenient way to hold the mobile device especially when driving. As such, a need has arisen for a device to hold and to display the screen of such mobile devices to the driver, so that the driver can safely drive a car while still being able to view the mobile device.

Usually, the mobile device holders use suction plates so that the mobile device holders are attached to the car windshield. Holders for small electronic device used to be either permanently mounted inside the car using a goose neck mechanism or attached to the windshield with a suction cup. A typical location of such could be far away from the driver thus making it difficult to see the details of the screen and requires more attention looking away from the road.

However, even if the user desires to attach the mobile device holder onto the interior console, it is not easy to attach the mobile device holder to the interior console because a structure of the interior console varies depending on the vehicle model and maker. The layout of many vehicles, in particular automobiles is rarely convenient to the use of such mobile devices. Typically, vehicle's interior lacks any space in which the smart phone may be placed for easy access. The use of cell phones is often hindered since the operator must simultaneously operate the vehicle. In modern large vehicles, such as SUVs and VANs, the windshield is located quite far from the driver and so any window-mounting holder for smart phones is not convenient in operation as they require a far reach for the driver to operate the device. Thus, a universal detachable holder is needed.

### SUMMARY OF THE DISCLOSURE

According to a present disclosure, a holder is provided. The holder includes a first connection member including at least one coupling member, a mobile device holding member attached to the first connection member and configured to accommodate a mobile device therein, and a second connection member including at least one receiving member configured to receive the at least one coupling member, and an attachment member configured to be attached to an external device, wherein the first connection member is interposed between the mobile device holding member and the second connection member, and wherein the at least one coupling member is detachably attached to the at least one receiving member.

The at least one coupling member includes a first coupling member including a button member and a locking member, wherein the button member is connected to the locking member, and wherein the locking member is configured to lock or release the at least one receiving member.

The first connection member includes a first connection board, wherein the at least one coupling member further includes a second coupling member, and wherein the first coupling member and the second coupling member are disposed on an upper portion and a lower portion of the first connection board, respectively.

The at least one receiving member includes a first receiving member and a second receiving member, wherein the first receiving member is disposed to face the first coupling member, and wherein the second receiving member is disposed to face the second coupling member.

The attachment member is detachably attached to the second connection member, and wherein the second connection member is interposed between the first connection member and the attachment member.

The second connection member includes a second connection board having a first side portion and a second side portion, wherein the first side portion and the second side portion face opposite directions and the first side portion faces the first connection member, and a rail groove configured to receive the attachment member, wherein the second connection board has a second connection through-hole penetrating the first side and the second side, and the at least one receiving member extended from the second connection board. The second connection board has an internal rail groove disposed on a circumference of the second connection through-hole.

The second connection member further includes a first sliding member and a second sliding member, wherein each of the first sliding member and the second sliding member has a first sliding hole and a second sliding hole, respectively, wherein the first sliding hole has a first sliding diameter and the second sliding hole has a second sliding diameter, and wherein the first sliding diameter is different from the second sliding diameter.

The rail groove includes an extended groove portion extended in a length direction of the rail groove and disposed in the first side portion with a first width, and a through-hole portion extended in the length direction of the rail groove and disposed ins the second side portion with a second width W2. The first width W1 is greater than the second width W2.

The rail groove further includes an entry hole having a diameter no smaller than the first width. The attachment member further includes a head portion having a head width corresponding to the first width, a body portion extended from the head portion, and having a body width corresponding to the second width, and a latch portion extended from the body portion and configured to be attached to the external device. The latch portion includes at least one of a first clip in a wedge-shape, a second clip having at least two elongated clip portions, a third clip having a third width, wherein the third width is larger than the second width, and a fourth clip in a circular arc shape.

The mobile device holding member includes a mobile device holding board, a first grip portion coupled to the mobile device holding board through an elastic member, and a second grip portion extended from the mobile device holding board.

The holder further includes a connector. The mobile holding member has a mobile holding member through-hole and the first connection member has a first connection member through-hole, and wherein the connector is elastically inserted in the mobile holding member through-hole and the first connection member through-hole.

The receiving member includes a first receiving member including a button member and a locking member. The button member is connected to the locking member configured to lock or release the at least one coupling member. The mobile device holding member is rotatably attached to the first connection member.

According to another embodiment, another holder is provided. The holder includes a mobile device holding member including at least one coupling member and configured to accommodate a mobile device therein, and a connection member including at least one receiving member configured to receive the at least one coupling member, and an attachment member configured to be attached to an external device. The at least one coupling member is detachably attached to the at least one receiving member.

The mobile device holding member further includes an attachment clip configured to be hung on a belt of a user. The connection member includes a connection board having a first side portion and a second side portion, wherein the first side portion and the second side portion face opposite directions and the first side portion faces the mobile device holding member, the at least one receiving member extending from the connection board, and a rail groove configured to receive the attachment member. The connection board has a connection through-hole penetrating the first side and the second side. The connection board has an internal rail groove disposed on a circumference of the connection through-hole. The connection member further includes a first sliding member and a second sliding member. Each of the first sliding member and the second sliding member has a first sliding hole and a second sliding hole, respectively. The first sliding hole has a first sliding diameter and the second sliding hole has a second sliding diameter. The first sliding diameter is different from the second sliding diameter. The rail groove includes an extended groove portion extended in a length direction of the rail groove disposed on the first side portion with a first width, and a through-hole portion extended in the length direction of the rail groove disposed formed on the second side portion with a second width W2. The first width W1 is greater than the second width W2. The rail groove further includes an entry hole having a diameter no smaller than the first width. The attachment member further includes a head portion having a head width corresponding to the first width, a body portion extended from the head portion, and having a body width corresponding to the second width, and a latch portion extended from the body portion and configured to be attached to the external device, wherein the latch portion includes at least one of a first clip in a wedge-shape, a second clip having at least two elongated clip portions, a third clip having a third width, wherein the third width is larger than the second width, and a fourth clip in a circular arc shape, and wherein the mobile device holding member includes a mobile device holding board, a first grip portion coupled to the mobile device holding board with an elastic member, and a second grip portion extended from the mobile device holding board.

The holder of the invention assures safety and convenience of the driver by allowing easy access to the mobile device as it is in arm's length. One of objects of the present disclosure is to overcome these and other drawbacks of the prior art by providing a seamless smart phone holder such as an iPhone or any other electronic devices. One of the objects of the present disclosure is to provide seamless access to interior console regardless of installment of the holder.

### BRIEF DESCRIPTION OF THE DRAWINGS

The disclosure will now be described in more detail with reference to exemplifying embodiments thereof and also with reference to the accompanying drawings.

FIG. 1 is an exploded perspective view of a holder according to an embodiment of the present disclosure.

FIG. 2 is an assembled perspective view of the holder according to another embodiment of the present disclosure.

FIG. 3 is a longitudinal cross-sectional view of the holder according to another embodiment of the present disclosure.

FIG. 4 illustrates a first connection member according to another embodiment of the present disclosure.

FIG. 5 illustrates a first mobile device holding member according to another embodiment of the present disclosure.

FIG. 6 illustrates an exploded perspective view of a second connection member according to another embodiment of the present disclosure.

FIG. 7 illustrates an assembled perspective view of the second connection member of FIG. 6 with sliding attachment members.

FIG. 8A illustrates a cross-section view taken along line A-A of FIG. 7. FIG. 8B depicts a cross-section view of an attachment member in FIG. 8A. FIG. 8C depicts a cross-section view of a rail groove in FIG. 8A.

FIG. 9 illustrates a transverse cross-sectional view of the holder according to another embodiment of the present disclosure.

FIG. 10 illustrates a cross-sectional view of the holder according to another embodiment of the present disclosure.

FIG. 11 illustrates a perspective view of a second connection member according to another embodiment of the present disclosure.

FIG. 12 illustrates an exploded perspective view of the holder according to another embodiment of the present disclosure.

FIG. 13 illustrates a top view of the holder, which is depicted in FIG. 12 and assembled and unfolded.

### DETAILED DESCRIPTION OF EXEMPLARY EMBODIMENTS

Reference will now be made in detail to embodiments, examples of which are illustrated in the accompanying drawings, wherein like reference numerals refer to the like elements throughout the several views. In this regard, the present embodiments may have different forms and should not be construed as being limited to the descriptions set forth herein. Accordingly, the embodiments are merely described below, by referring to the figures, to explain aspects of the present description. Terms used herein are for descriptive purposes only and are not intended to limit the scope of the disclosure. The terms “comprises” and/or “comprising” are used to specify the presence of stated elements, steps, operations, and/or components, but do not preclude the presence or addition of one or more other elements, steps, operations, and/or components. The terms “first,” “second,” and the like may be used to describe various elements, but do not limit the elements. Such terms are only used to distinguish one element from another.

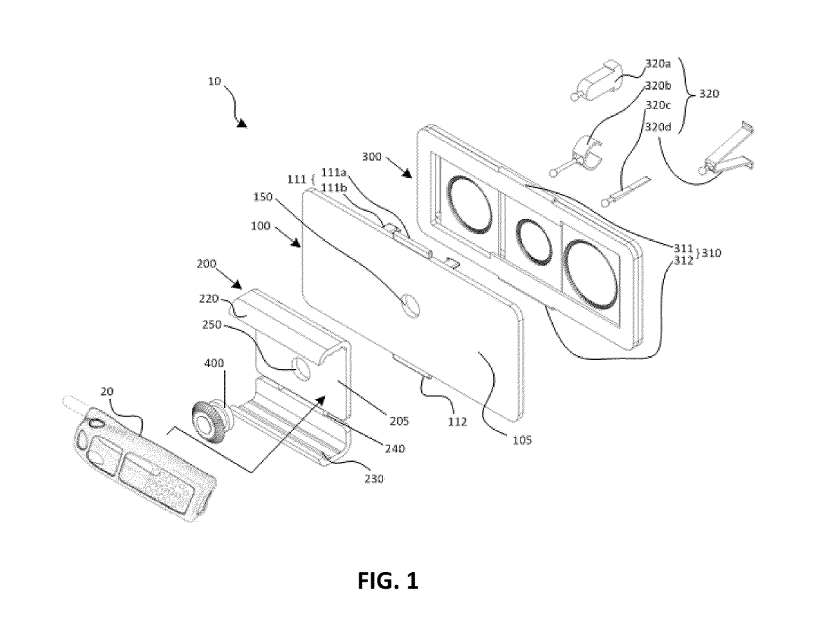

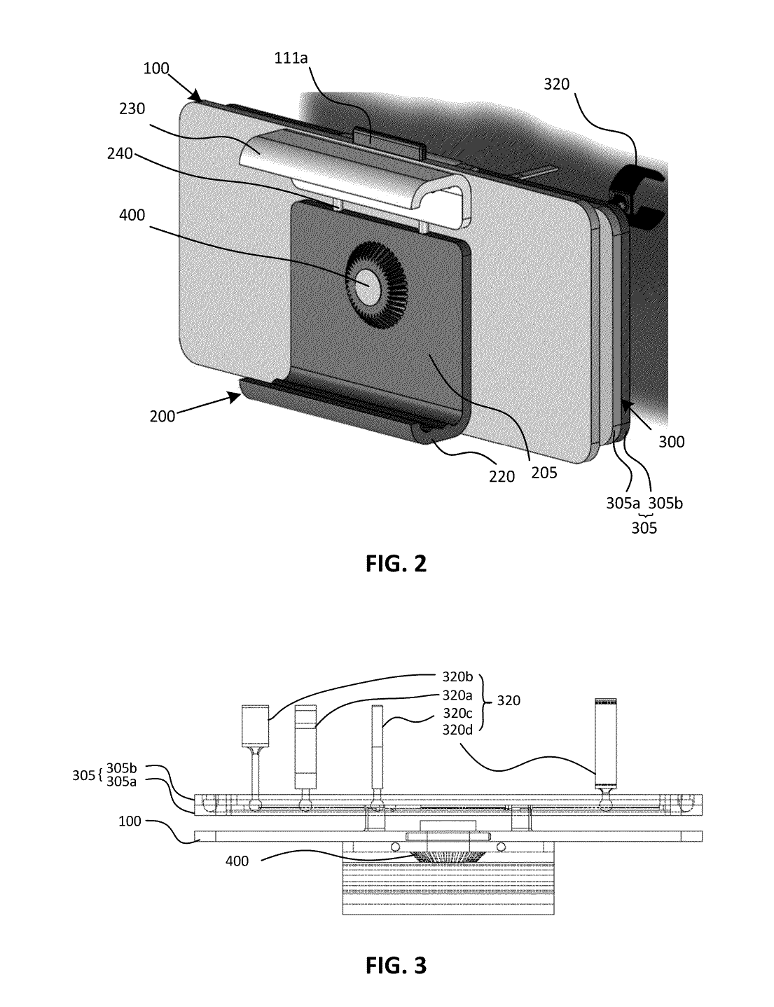

FIG. 1 is an exploded perspective view of a holder according to an embodiment of the present disclosure. FIG. 2 is an assembled perspective view of the holder according to another embodiment of the present disclosure. FIG. 3 is a longitudinal cross-sectional view of the holder according to another embodiment of the present disclosure.

According to an embodiment of the present disclosure, a holder 10 is provided. The holder 10 is devised to hold a mobile device 20 onto an external device. The mobile device 20, for instance, includes a portable and handheld computing device. The mobile device 20 includes a portable computer device such as a tablet computer (iPad®), Personal Digital Assistant (“PDA”), and GPS navigation; a cellular phone; Portable Multimedia Players (PMPs); a smartphone; and a wearable device including a smart watch, a smart band, and a smart glass. Conventionally, the mobile device 20 may include a display screen with input devices such as a touch pad, a button, and a miniature keyboard. The mobile device 20 may have a Global Positioning System (“GPS”) or wireless communication capabilities. For instance, the mobile device 20 may be connected to internet or Bluetooth-capable devices. The mobile device 20 may have an operating system (OS) and may run various application software. While a smart phone will be described as an example of the mobile device 20 herewith; however, the example of the mobile device 20 would not be limited thereto.

The holder 10 is devised for holding the mobile device 10 near the external device. For exemplary purposes only, the holder 10 can be located in a motor vehicle and can be located near on a console of the motor vehicle (not shown), in order to keep the mobile device 10 near a user in the car without holding the mobile device 20 in his hand.

According to the embodiment of the present disclosure, the holder 10 includes a first connection member 100, a mobile device holding member 200, and a second connection member 300. Each element of the holder 10 will be described further along with drawings.

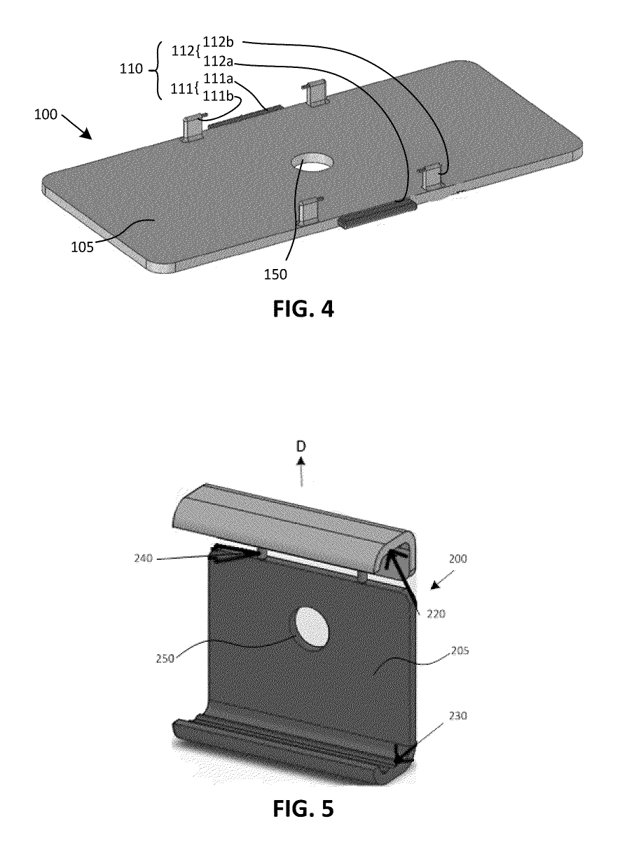

FIG. 4 illustrates the first connection member 100 according to another embodiment of the present disclosure. Referring to FIG. 4, the first connection member 100 includes a first connection board 105, at least one coupling member 110, and a first connection member through-hole 150.

The first connection board 105 can be, for exemplary purposes only, a flat board in a rectangular shape elongated in one direction. The shape of the first connection board 105 is not limited thereto but can be any suitable shape, e.g., a U-shape or any polygon that may be selected by those skilled in the art.

The at least one coupling member 110 includes a first coupling member 111 and a second coupling member 112. For the purpose of exemplary only, the first coupling member 111 is described hereafter only; however, the second coupling member 112 can have a same or similar function therewith. The number of the at least one coupling member 110 is also not limited thereto but any suitable number of the at least one coupling member 110 that may be selected by those skilled in the art.

The first coupling member 111 includes a button member 111a and a locking member 111b. The button member 111a is mechanically or electrically connected to the locking member 111b. For instance, the locking member 111b is configured to lock or to release the second connection member 300 when a user pushes the button member 111a. In particular, the at least one coupling member 100 is configured to lock or release at least one receiving member 310. Referring to FIG. 4, the second coupling member 112 has a button member 112a and a locking member 112b as well.

As depicted in FIGS. 1 and 4, the first coupling member 111 and the second coupling member 112 can be disposed on the opposite sides of the first connection board 105. In FIG. 4, the first coupling member 111 and the second coupling member 112 are disposed on the top and bottom portions of the first connection board 105, respectively. However, the location of the first coupling member 111 and the second coupling member 112 are not limited thereto. For instance, the first coupling member 111 and the second coupling member 112 can be disposed on the right and left portions of the first connection board 105, respectively, or one side portion of the first connection board 105 only. Alternatively, a plural number of the coupling members (not shown) can be located around the edges of the first connection board 105.

The first connection member 100 has the first connection member through-hole 150 therein. Although a shape of the first connection member through-hole 150 is depicted in a circular shape, the shape thereof is not limited thereto.

FIG. 5 illustrates a first mobile device holding member 200 according to another embodiment of the present disclosure. Referring to FIG. 5, the mobile device holding member 200 includes a mobile device holding board 205, a first grip portion 220, and a second grip portion 230, an elastic member 240, and a mobile holding member through-hole 250.

The mobile device holding board 205 has a structure to accommodate the mobile device 20. The first grip portion 220 is extended from the mobile device holding board 205. The second grip portion 230 is extended from the mobile device holding member 205 in a direction opposite to the first grip portion 220. Each of the first grip portion 220 and the second grip portion 230 may be fabricated from an elastic material so that the user can easily grip and maneuver the first mobile device holding member 200.

The first grip portion 220 is coupled to the mobile device holding board 205 with an elastic member 240. The elastic member 240 may include a spring and a rubber. Thus, the first grip portion 220 is configured to move back and forward with respect to the mobile device holding board 205 as denoted by arrow D. The first grip portion 220 is configured to move back and forward so as to hold the mobile device 20 in various sizes.

The mobile device holding board 205 has the mobile holding member through-hole 250 therein. Although a shape of the mobile holding member through-hole 250 is depicted in a circular shape, the shape thereof is not limited thereto.

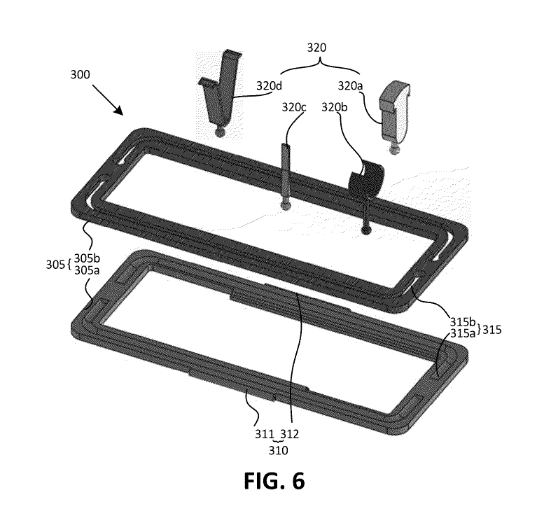

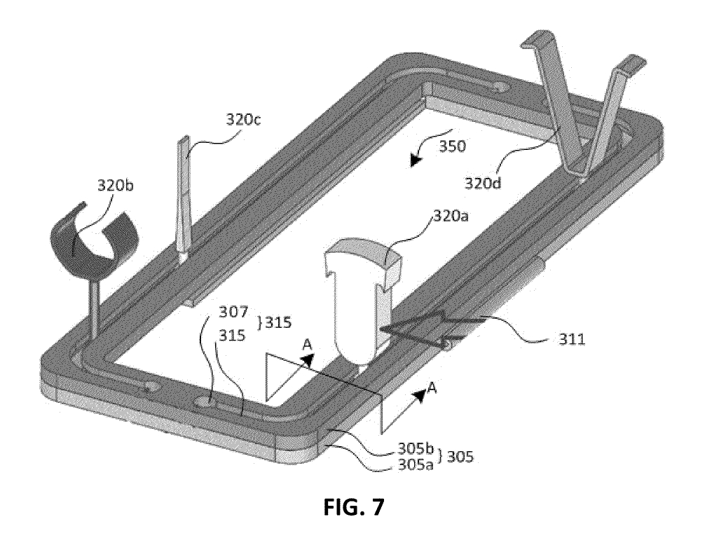

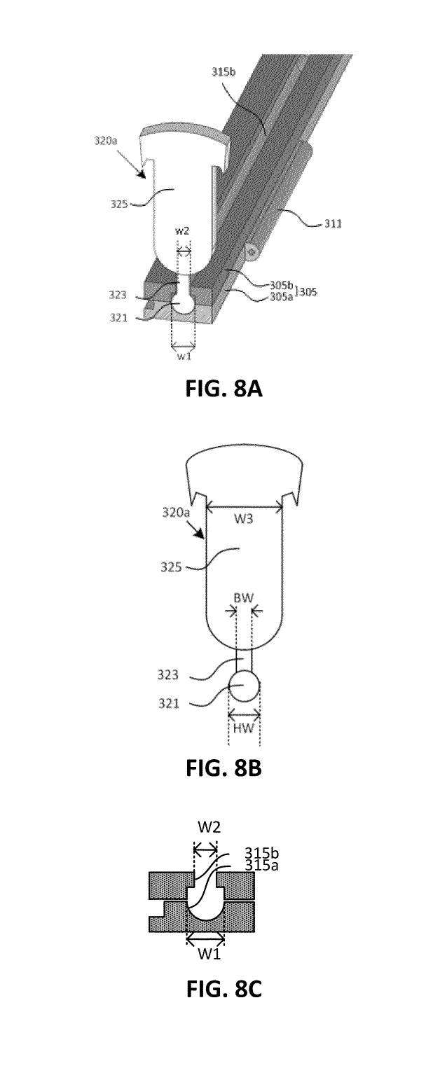

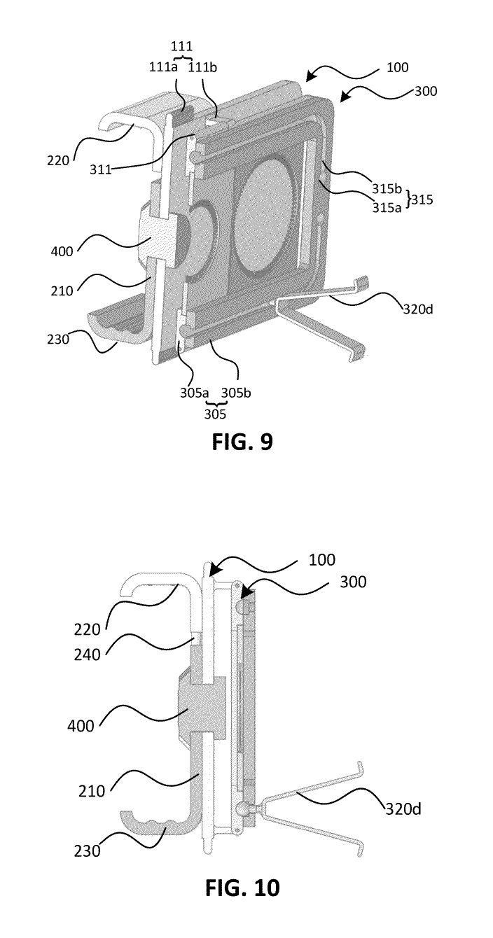

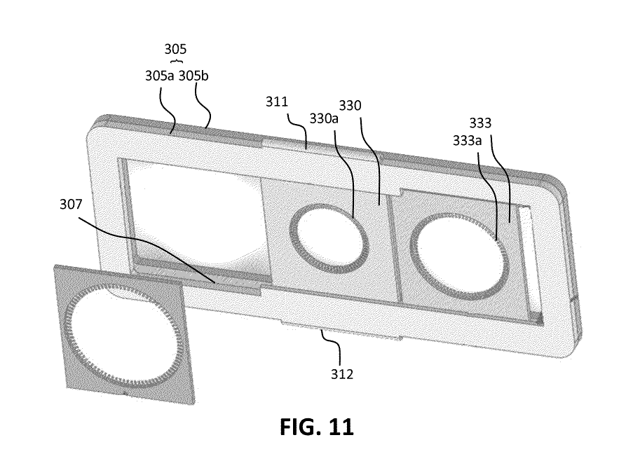

FIG. 6 illustrates an exploded perspective view of a second connection member 300 according to another embodiment of the present disclosure. FIG. 7 illustrates an assemble perspective view of the second connection member 300 of FIG. 6 with sliding attachment members. FIG. 8A illustrates a cross-section view taken along line A-A of FIG. 7. FIG. 8B depicts a cross-section view of an attachment member in FIG. 8A. FIG. 8C depicts a cross-section view of a rail groove in FIG. 8A. FIG. 9 illustrates a transverse cross-sectional view of the holder according to another embodiment of the present disclosure. FIG. 10 illustrates a cross-sectional view of the holder according to another embodiment of the present disclosure. FIG. 11 illustrates a perspective view of a second connection member according to another embodiment of the present disclosure.

Referring to FIGS. 6-11, the second connection member 300 includes a second connection board 305, at least one receiving member 310, a rail groove 315, and an attachment member 320.

For exemplary purposes only, the second connection board 305 may include a first side portion 305a and a second side portion 305b. Although the first side portion 305a and the second side portion 305b are separately depicted in FIG. 6, the first side portion 305a and the second side portion 305b may constititue an integral structure. The first side portion 305a and the second side portion 305b face opposite directions. For example, the first side portion 305a faces the first connection member 100. The second connection board 305 has a connection through-hole 350 therein. Although the connection through-hole 350 is depicted in a rectangular shape in FIG. 7, the shape thereof is not limited thereto.

The at least one receiving member 310 may be extended from the second connection board 305. The at least one receiving member 310 is configured to receive the at least one coupling member 110. The at least one receiving member 310 includes a first receiving member 311 and a second receiving member 312. The first receiving member 311 is disposed to face the first coupling member 111. The second receiving member 312 is disposed to face the second coupling member 112. The number and location of the at least one receiving member 310 are not limited thereto but any suitable number and location of the at least one receiving member 310 may be selected by those skilled in the art. Each of the first receiving member 311 and the second receiving member 312 is configured to receive the locking members 111b and 112b, respectively. The at least one receiving member 310 is interchangeably configured with the at least one coupling member 110. In other words, the at least one receiving member 310 can be disposed on the first connection member 100. At the same time, the at least one coupling member 110 can be disposed on the second connection member 200.

Referring to FIGS. 8A, 8B, and 8C, the rail groove 315 has an extended groove portion 315a and a through-hole portion 315b. The rail groove 315 is devised to hold the attachment member 320, and the attachment member 320 can detachably attach the holder 10 to the external device. The external device can have various concave and convex shapes. For example, when the external device refers to a car interior console, depending on models of the vehicle, the interior console may have different shape and number of functional structures, e.g., air condition buttons, car heater fans, cassette buttons, or audio buttons. Since the attachment member 320 can be moved along the rail groove 315, it provides a greater flexibility of the location of the attachment member 320. Thus, the holder 10 can be attached to various external devices regardless of their structural differences due to the attachment member's 320 movability along the rail groove 315.

The extended groove portion 315a is extended in a length direction of the rail groove 315. The extended groove portion 315a is formed on the first side portion 305a with a first width W1. One side of the extended groove portion 315a can be closed. In FIGS. 8A, 8B, and 8C, the rail groove 315 is formed around the edge of the second connection board 305 and the extended groove portion 315a is formed in reply to the shape of the rail groove 315. However, the shape of the rail groove 315 is not limited thereto.

The through-hole portion 315b is extended in the length direction of the rail groove 315. The through-hole portion 315b is formed on the second side portion 305b with a second width W2 and penetrates the second side portion 305b. The first width W1 is greater than the second width W2. The rail groove 315 further includes an entry hole 317.

The attachment member 320 is configured to be detachably attached to the external device. At the same time, the attachment member 320 is detachably attached to the second connection member 300. Thus, the second connection member 300 is detachably attached to the external device by the attachment member 320. The second connection member 300 is interposed between the first connection member 100 and the attachment member 320.

The attachment member 320 includes a head portion 321, a body portion 323, and a latch portion 325. The head portion 321 has a head width HW corresponding to the first width W1. The body portion 323 is extended from the head portion 321 and has a body width BW corresponding to the second width W2. The latch portion 325 is extended from the body portion 323 and is configured to be attached to the external device.

The entry hole 317 has a diameter no smaller than the first width W1. When a user inserts the attachment member 320 into the rail groove 315, the entry hole 317 provides enough space to receive the head portion 321 and the body portion 323 of the attachment member 320. As depicted in FIG. 8C, due to the dimensions of the attachment member 320, the head portion 321 and the body portion 323 are configured to be slid along the rail groove 315.

The latch portion 325 can have various shapes depending on the shape of external device. According to one embodiment of the present disclosure, the latch portion 325 can have an ending body 320a with a third width W3. The ending body 320a may be comprised of elastic material. Thus, the ending body can be inserted into a different size hole with shredded elastic force. The third width W3 can be greater than the second width W2. According to another embodiment of the present disclosure, the latch portion 325 can have a clip in a circular arc shape 320b as depicted in FIG. 6. According to another embodiment of the present disclosure, the clip can be hung on any gap on the interior console, such as a CD player slot. According to another embodiment of the present disclosure, the latch portion 325 can have a clip in a wedge-shape 320c as depicted in FIG. 6. According to another embodiment of the present disclosure, the latch portion 325 can have at least two elongated clip portions 320d as depicted in FIG. 6. The second connection member 300 can have at least one of or a combination of the various attachment members 320. For instance, the second connection member 300 can have four (4) clips in a wedge-shape 320c and two (2) ending bodies 320a.

The second connection board 305 may have an internal rail groove 307 formed on a circumference of the second connection through-hole 350 as shown in FIG. 11. The second connection member 300 further includes a first sliding member 330 and a second sliding member 333. Each of the first sliding member 330 and the second sliding member 333 is configured to slide along the internal rail groove 307 and detachably attached to the internal rail groove 307. Each of the first sliding member 330 and the second sliding member 333 has a first sliding hole 330a and a second sliding hole 333a. The first sliding hole 330a has a first sliding diameter. The second sliding hole 333a has a second sliding diameter. The first sliding diameter is different from the second sliding diameter. When the holder 10 is attached to the interior console (not shown), various protruded buttons of the interior console (not shown) may obstruct the attachment of the holder and the interior console (not shown). Thus, a user can select among a plurality of sliding members 330 and 333, which are suitable for the shape of the targeted interior console.

Now with reference to FIGS. 1, 2, 9 and 10, structural relationships among the first connection member 100, the mobile device holding member 200, and the second connection member 300 will be further described.

The first connection member 100 is interposed between the mobile device holding member 200 and the second connection member 300. The mobile device holding member 200 is rotatably attached to the first connection member 100. The mobile device holding member 200 is detachably attached to the first connection member 100. The first connection member 100 is detachably attached to the second connection member 300. The second connection member 300 is detachably attached to the external device (not shown).

With reference to FIG. 1, any one of the first coupling member 111 and the second coupling member 112 is selectively attached to any one of the first receiving member 311 and the second receiving member 312. When the mobile device 20 is attached to the mobile device holding member 200, and the first connection member 100 covers the protruded buttons of the interior console (not shown), the user can release any one of the first coupling member 111 and the second coupling member 112. For instance, if the user releases the first coupling member 111, since the second coupling member 112 is still connected to the second receiving member 312, the first connection member 100 can be rotatably moved with respect to an axis of the second coupling member 112. Thus, the user can use the buttons of the interior console (not shown) without detaching the mobile device 20 from the holder 10.

With reference to FIGS. 9 and 10, a connector 400 can be inserted into the first connection member through-hole 150 and the mobile holding member through-hole 250. The mobile device holding member 200 is rotatably attached to the first connection member 100 with respect to an axis of the connector 400. The connector 400 can be comprised of elastic materials.

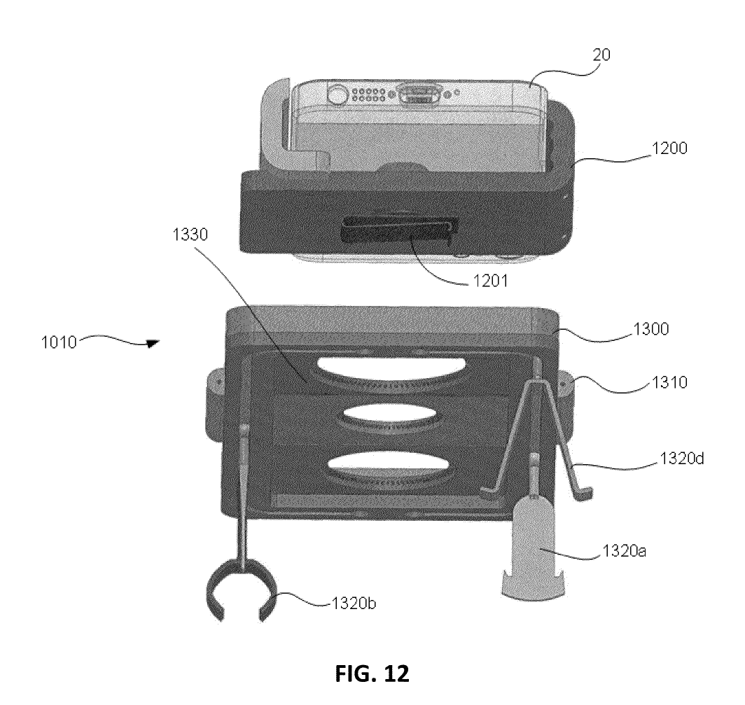

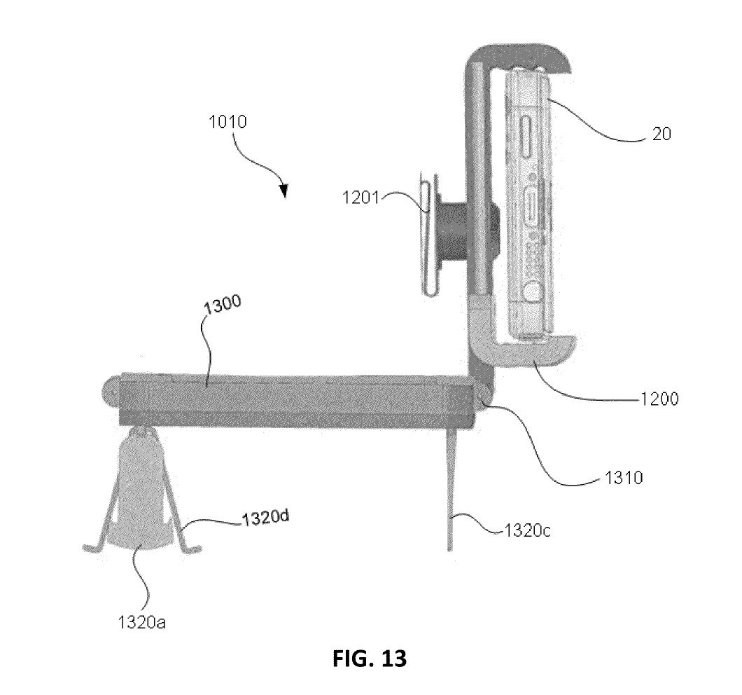

FIG. 12 illustrates an exploded perspective view of the holder according to another embodiment of the present disclosure. FIG. 13 illustrates a top view of the holder, which is depicted in FIG. 12 and assembled and unfolded.

According to another embodiment of the present disclosure, the holder 1010 includes a mobile device holding member 1200, and a second connection member 1300. In comparison with FIG. 1, the holder 1010 lacks the first connection member 100. In other words, the mobile device 20 is accommodated in the mobile device holding member 1200 which is detachably attached to the second connection member 1300. The mobile device member 1200 can have a coupling member (not shown) which is connectable to a receiving member 1310. The mobile device holding member 1200 has an attachment clip 1201. The attachment clip 1201 is configured to be hung on a belt or a pocket around a user's waist or any part of a body. Thus, the mobile device holding member 1200 can function as a protective cover of the mobile device 20. The user can detach the mobile device holding member 1200 from his/her belt and attach onto the second connection member 1300.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly. the disclosure and the figures are to be regarded as illustrative rather than restrictive.

What is claimed is:

1. A holder comprising:
a first connection member comprising at least one coupling member;
a mobile device holding member attached to the first connection member and configured to accommodate a mobile device therein; and
a second connection member comprising:
at least one receiving member configured to receive the at least one coupling member; and
an attachment member configured to be attached to an external device,
wherein the first connection member is interposed between the mobile device holding member and the second connection member, and wherein the at least one coupling member is detachably attached to the at least one receiving member.

2. The holder of claim 1, wherein the at least one coupling member comprises a first coupling member including a button member and a locking member, wherein the button member is connected to the locking member, and wherein the locking member is configured to lock or release the at least one receiving member.

3. The holder of claim 2, wherein the first connection member comprises a first connection board, wherein the at least one coupling member further comprises a second coupling member, and wherein the first coupling member and the second coupling member are disposed on an upper portion and a lower portion of the first connection board, respectively.

4. The holder of claim 3, wherein the at least one receiving member comprises a first receiving member and a second receiving member, wherein the first receiving member is disposed to face the first coupling member, and wherein the second receiving member is disposed to face the second coupling member.

5. The holder of claim 1, wherein the attachment member is detachably attached to the second connection member, and wherein the second connection member is interposed between the first connection member and the attachment member.

6. The holder of claim 1, wherein the second connection member comprises:
a second connection board having a first side portion and a second side portion, wherein the first side portion and the second side portion face opposite directions and the first side portion faces the first connection member; and
a rail groove configured to receive the attachment member,
wherein the second connection board has a second connection through-hole penetrating the first side and the second side, and
wherein the at least one receiving member extended from the second connection board.

7. The holder of claim 6, wherein the second connection board has an internal rail groove disposed on a circumference of the second connection through-hole.

8. The holder of claim 6, wherein the second connection member further comprises a first sliding member and a second sliding member, wherein each of the first sliding member and the second sliding member has a first sliding hole and a second sliding hole, respectively, wherein the first sliding hole has a first sliding diameter and the second sliding hole has a second sliding diameter, and wherein the first sliding diameter is different from the second sliding diameter.

9. The holder of claim 6, wherein the rail groove comprises:
an extended groove portion extended in a length direction of the rail groove and disposed in the first side portion with a first width; and
a through-hole portion extended in the length direction of the rail groove and disposed ins the second side portion with a second width W2,
wherein the first width W1 is greater than the second width W2.

10. The holder of claim 9, wherein the rail groove further comprises an entry hole having a diameter no smaller than the first width.

11. The holder of claim 9, wherein the attachment member further comprises:
a head portion having a head width corresponding to the first width;
a body portion extended from the head portion, and having a body width corresponding to the second width; and
a latch portion extended from the body portion and configured to be attached to the external device.

12. The holder of claim 11, wherein the latch portion comprises at least one of:
a first clip in a wedge-shape;
a second clip having at least two elongated clip portions;
a third clip having a third width, wherein the third width is larger than the second width; and
a fourth clip in a circular arc shape.

13. The holder of claim 1, wherein the mobile device holding member comprises:
a mobile device holding board;
a first grip portion coupled to the mobile device holding board through an elastic member; and
a second grip portion extended from the mobile device holding board.

14. The holder of claim 1, wherein the holder further comprises a connector, wherein the mobile holding member has a mobile holding member through-hole and the first connection member has a first connection member through-hole, and wherein the connector is elastically inserted in the mobile holding member through-hole and the first connection member through-hole.

15. The holder of claim 1, wherein the receiving member comprises a first receiving member including a button member and a locking member, and wherein the button member is connected to the locking member configured to lock or release the at least one coupling member.

16. The holder in claim 1, wherein the mobile device holding member is rotatably attached to the first connection member.

17. A holder comprising:
a mobile device holding member comprising at least one coupling member and configured to accommodate a mobile device therein; and
a connection member comprising:
at least one receiving member configured to receive the at least one coupling member; and
an attachment member configured to be attached to an external device,
wherein the at least one coupling member is detachably attached to the at least one receiving member.

18. The holder of claim 17, wherein the mobile device holding member further comprises an attachment clip configured to be hung on a belt of a user.

19. The holder of claim 17, wherein the connection member comprises:
a connection board having a first side portion and a second side portion, wherein the first side portion and the second side portion face opposite directions and the first side portion faces the mobile device holding member, the at least one receiving member extending from the connection board; and
a rail groove configured to receive the attachment member,
wherein the connection board has a connection through-hole penetrating the first side and the second side,
wherein the connection board has an internal rail groove disposed on a circumference of the connection through-hole,
wherein the connection member further comprises a first sliding member and a second sliding member,
wherein each of the first sliding member and the second sliding member has a first sliding hole and a second sliding hole, respectively,
wherein the first sliding hole has a first sliding diameter and the second sliding hole has a second sliding diameter,
wherein the first sliding diameter is different from the second sliding diameter,
wherein the rail groove comprises an extended groove portion extended in a length direction of the rail groove disposed on the first side portion with a first width; and a through-hole portion extended in the length direction of the rail groove disposed formed on the second side portion with a second width W2,
wherein the first width W1 is greater than the second width W2,
wherein the rail groove further comprises an entry hole having a diameter no smaller than the first width,
wherein the attachment member further comprises:
a head portion having a head width corresponding to the first width;
a body portion extended from the head portion, and having a body width corresponding to the second width; and
a latch portion extended from the body portion and configured to be attached to the external device,
wherein the latch portion comprises at least one of:
a first clip in a wedge-shape;
a second clip having at least two elongated clip portions;
a third clip having a third width, wherein the third width is larger than the second width; and
a fourth clip in a circular arc shape, and wherein the mobile device holding member comprises:
a mobile device holding board;
a first grip portion coupled to the mobile device holding board with an elastic member; and
a second grip portion extended from the mobile device holding board.
